(19) United States
(12) Patent Application Publication
(10) Pub. No.: US 2026/0319464 A1
(43) Pub. Date: Oct. 15, 2026

(54) PROCESS CHARACTERISTIC NUMBER DETERMINATION

(71) Applicant: ARBURG GMBH + CO KG, Lossburg (DE)

(72) Inventors: Werner FAULHABER, Lossburg Wittendorf (DE); Gunther SCHMID, Horb am Neckar (DE)

(21) Appl. No.: 19/122,431

(22) PCT Filed: Oct. 18, 2023
(86) PCT No.: PCT/EP2023/078964

§ 371 Date: Apr. 18, 2025

(30) Foreign Application Priority Data
Oct. 18, 2022 (DE) 10 2022 127 260.5

(51) Int. Cl. G05B 19/4155

(52) U.S. Cl. CPC G05B 19/4155; G05B 2219/37239

(57) ABSTRACT

In a method for determining process characteristic numbers on a cyclically operating machine for processing plasticisable material for generating mouldings, in an iterative process in process cycles of a reference determination cycle at least partial curve progressions (10) of measurement variables are determined and stored, and the curve progressions are processed preferably at least in a single-stage manner by means of mathematical and/or statistical methods. Herefrom, first process characteristic numbers (30) at characteristic points for the processed curve progressions (25) are determined and stored, and herefrom further process characteristic numbers (40) found by means of indexing (80) and deviations from reference process characteristic numbers are determined and stored. By applying deviation-dependent stored values in an automatic compensation intervention to predetermined correcting variables at changing production conditions, the process characteristic numbers (30, 40) are updated in the production cycle.

### REFERENCE TO RELATED APPLICATIONS

The present application relates to and claims the priority of German patent application 10 2022 127 260.5, filed on Oct. 18, 2022, the disclosure of which is hereby expressly, in its entirety, made part of the subject matter of the present application.

### TECHNICAL FIELD

The disclosure relates to a method for determining process characteristic numbers on a cyclically operating machine for processing plastics and other plasticizable materials for producing moldings, a cyclically operating machine for processing plastics and other plasticizable materials for producing moldings for carrying out the method, and a computer program product comprising a program code stored on a computer-readable medium for carrying out the method.

The term “plasticizable material,” as used here, is to be understood broadly and includes in particular, but not only, in addition to plastics or also silicone or other thermoplastic and/or elastomeric materials, e.g., ceramic, metallic and/or powdery masses as well as paper, cellulose, starch, cork, etc. and also mixed materials between such plasticizable materials. Generally principle, these can also be previously plasticized materials or plastic masses that cure automatically or with the use of additives after application. The term also includes recyclates.

The term “process characteristic number,” as used here, refers to a variable obtained from data using mathematical methods that is suitable for quantitatively evaluating a process status (at least in part, possibly in combination with other process characteristic numbers) and thus also making it accessible for quantitative comparisons and possibly compensation interventions. In the following, the term process characteristic number is also used if this variable does not originate from the process itself in the form of a sensor signal, but can be taken from process-relevant data sources, such as material data, which can be made accessible for evaluation in accordance with the disclosed method.

When the term “curve profile” is used, it need not only refer to measurement curve profiles from the process, but can also refer to other curve profiles the content of which can be inferred from the disclosed method. The term “curve profiles” preferably also includes sub-portions or even individual measuring points. Where it is helpful for better understanding, the terms are differentiated.

When the term “derived” curve profiles is used, this refers to any conceivable processing using mathematical methods to arrive at further curve profiles that can be generated from the basic curve profile. In individual cases, this can also be a mathematical derivation. Where mathematical derivation is explicitly meant, this is indicated.

### BACKGROUND

Input variables for calculating process characteristic numbers, such as pressure profiles, position profiles, speed profiles, temperature profiles, torque profiles, etc. are known, as are the curves of additional, non-machine-based sensors. All measurement signals required by the production system, e.g., an injection molding machine, for its intended function can be used without further effort. The use of further signals of all conceivable physical variables, which are usable explicitly for monitoring purposes in any part of the production system, is also known.

Determining process characteristic numbers such as peak values of signal curves, area integrals under signal curves, etc. as singular cyclical values is also known. These characteristic numbers are used to measure the stability of the process and, if necessary, instances of overshooting of set tolerances are used to select finished parts that have been supposedly produced under unstable process conditions. If the machine setting parameters are changed by the operator, suitable tolerances must be regularly recalculated and set. This can significantly increase the complexity of a machine setting change.

Methods for the automatic readjustment of machine setting parameters of the process with the aim of compensating for deviations are also known. The usual setting parameters of the production system are used for this purpose, such as setpoint values for speeds, pressures, temperatures and other switching points between process phases.

In WO 91/14562 A1 such a method is disclosed, which performs the following steps: inputting a reference characteristic of the material used, for the article or articles to be molded; comparing the reference characteristic with a measured actual characteristic from an immediately preceding shot in order to obtain a set value; adjusting the injection molding machine in accordance with the set value; executing a shot. Here, complete process signal curves are compared with each other and an offset is determined.

EP 2 583 811 B1 describes a method that follows the same approach as WO 91/14562 A1 in a somewhat more abstract form, wherein transformation methods are used to determine the deviations between the reference and current process curve. The variables that can be measured or adjusted at the production plant are again used as input and output parameters. Here too, complete process curve profiles are compared with each other and an offset and/or scaling factor, for example, is determined therefrom.

The main disadvantage of both of the aforementioned methods is the need to record complete curve profiles before they can be processed to determine a correction factor.

WO 96/09926 A1 discloses a method for automatically influencing machine setting variables in cyclical processes, in which, after a determination for test purposes of characteristic properties of parts manufactured in the test phase and simultaneous determination of a large number of process curve profiles, a relationship is created between process characteristic numbers characterizing the process curve profiles and the characteristic properties of the parts. Corresponding process characteristic numbers are also determined during production. This signal analysis creates the prerequisite that, when a desired characteristic property is specified, the process characteristic numbers relevant for this can be determined in order to determine the machine setting variables relevant for the characteristic property. During production, the expected characteristic property can then be calculated, so that on the basis of a setpoint-actual value comparison a difference value can be determined, which is controllable to a minimum by influencing of the likewise calculated relevant machine setting variable. This has the disadvantage that a great deal of effort is required to carry out tests and to evaluate and model each individual process.

WO 97/12740 A2 discloses a method for controlling the cavity pressure curve on a cyclically operating machine, in which the cavity pressure is recorded during the cycle over time and/or over the distance traveled by the conveying means. The cavity pressure curve is then differentiated according to time or distance. A check is then carried out to reveal whether there are any deviations from the monotonic curve using the previously determined derivations. If this is the case, the holding pressure time or the switching time is changed until the profile of the cavity pressure curve is monotonic. The method selectively examines the cavity pressure curve and is therefore limited in its applicability to the specific application, namely to eliminate discontinuities in this signal curve.

TW 201706112 A discloses a method for providing parameters of an injection device comprising a screw conveyor having a screw diameter. The method comprises the following steps: obtaining a total injection volume based on a mold model; using mold analysis software to draw a preset shape curve of the screw feed rate versus the mold fill rate, wherein the preset shape curve contains a plurality of fixed points and each of the fixed points contains a mold fill rate and a screw feed rate; using the mold fill rate of each of the fixed points, the screw diameter, and the total injection volume to determine a corresponding stroke position; and providing each of the stroke positions corresponding to the fixed points for the injection device The disadvantage is the need to refer to simulation data.

DE 10 2018 107 233 A1 describes a method for automatic process monitoring and/or process diagnosis of a piece-based process, in particular an injection molding process. The method comprises the following steps: performing an automated reference finding for obtaining reference values from values of at least one process variable; performing an anomaly detection on the basis of the reference values found in the first step; performing an automated cause analysis and/or an automated fault diagnosis on a basis of a qualitative model of process interrelationships and/or on the basis of interdependencies of different process variables. Anomaly detection as the basis of the method limits it to deviations that are statistically significantly removed (i.e., several times the natural process variation) from the stable process. It can therefore only react to gross process disturbances.

DE 10 2020 125 655 A1 describes a method for determining a setpoint value curve for a process parameter acting as a manipulated variable in a production cycle in a first configuration of an injection molding machine. In the method, a setpoint value curve for the one process parameter acting as a manipulated variable is defined in at least one production cycle such that an actual value curve for the selected variable has a desired property or provides the desired actual value curve. In a second embodiment of the method, the actual value curve present in relation to the first embodiment of the method is specified as a reference value curve for the selected variable and a setpoint value curve for the process parameter acting as a manipulated variable is defined by a computer. This is done in such a way that the reference value curve results as an actual value curve with the desired at least one property or the desired actual value curve itself when the injection molding machine present in the second configuration operates in a production cycle according to the selected setpoint value curve for the at least one process parameter acting as a manipulated variable. The method aims to adapt a complete curve profile to a reference curve profile and therefore has the above-mentioned disadvantages of these methods. It cannot be assumed that the reproduction of a desired curve profile under changed boundary conditions (e.g., changed material properties) will keep the quality of the produced moldings constant.

DE 10 2021 109 851 A1 discloses a method for comparing a simulation of a process to be carried out with an injection molding machine with the process actually carried out, wherein at least one simulation curve of a variable characteristic of the process, in particular a simulated pressure curve, is calculated as part of the simulation. In the process actually carried out, at least one measurement curve of the characteristic variable, in particular a measured pressure curve, is measured. In addition, the first marked points of the curve of the at least one simulation curve and second marked points of the curve of the at least one measurement curve are determined. In this case, the first marked points and the second marked points are at least partially associated with one another, wherein at least one change parameter for the simulation and/or the process is calculated from coordinates of the at least partially associated first marked points and second marked points, and the simulation and/or the process is changed on the basis of the at least one change parameter and carried out again. Disadvantageously, this requires reference to simulation data.

US 2008/152748 A1 describes an injection molding machine in which a screw is moved in a state in which a non-return ring is in an open state when the screw is moved forward after completion of a metering step. The resin flows in a direction opposite to the injection direction. The backflow of the resin exerts a rotational force on the screw. When the non-return ring closes a resin passage, the rotational force acting on the screw is reduced. A peak value of the screw rotation force is recognized as the closing time of the non-return ring. Physical variables such as the screw torque and the screw position at this time are recorded. As the closing time of the non-return ring is detected precisely, the correction of the injection/holding pressure switching position and the injection speed switching position can be set more precisely. The recorded physical variable can be used to determine whether a molding is fault-free or faulty.

EP 997 257 B1 discloses a method for controlling a movement sequence of a first movable component of a plastics injection molding machine, the movement path of which is at least partially overlapped by the movement path of a second movable component of the plastics injection molding machine. The movement of the first movable component is started as a function of a release signal representing a movement state of the second movable component, wherein at least one time measure is determined. A first time measure and a second time measure are determined and compared with one another, wherein the first time measure indicates the time interval between the time at which the release signal is generated and the time at which the first movable component reaches the path of movement of the second movable component, and wherein the second time measure indicates the time interval between the time at which the release signal is generated and the time at which the second movable component leaves the path of movement of the first movable component. The movement sequence of the first movable component is controlled as a function of the comparison of the two time measures such that the difference between the second time measure and the first time measure is smaller than a predetermined, minimum tolerance value.

U.S. Pat. No. 8,641,943 B1 shows a method for filling a mold with a compressible liquid material. The mold is connected to a manifold via a plurality of channels, wherein at least one valve is arranged in at least one of the channels. A controller is configured to pressurize the manifold with the liquid material and modulate the valve to perform a plurality of pulse cycles during a filling cycle. A pulse cycle comprises adjusting an opening of the valve from a first position to a second position and adjusting the opening of the valve from the second position to a third position, wherein the opening corresponding to the second position is larger than the opening corresponding to the first position and the opening corresponding to the third position is smaller than the opening corresponding to the second position. In addition, the pulse cycle control parameters stored in the data memory can be selected based on measured values during a mold filling cycle. For example, various parameters such as dwell times and threshold values may vary during a mold filling cycle depending on a measured value such as the orientation of an impeller in the pressurization device, a pressure or a temperature of the liquid material, or an indication of the mold filling progress, such as a percentage of the mold volume filled.

The above-mentioned documents, in combination, exhibit one or more of the following problems. The methods
require a great deal of testing and modeling,
are dependent on the use of simulation data,
are not aimed at consistency of the quality of the molding produced,
are already severely limited in their effect from the outset,
require the recording of complete curve profiles before evaluation.

Further distinguishing features of the present method compared to the methods mentioned are, for example
a) The calculated characteristic numbers
   are each based on only a single process curve profile,
   shift when the operator consciously changes the machine settings during the course of the process,
   change their order of magnitude so that they lose their informative value,
   are no longer detectable because the process signal curve changes its characteristics significantly as a result of machine setting changes or process deviations,
   are interdependent, even if they are determined from different physical variables.
b) The input signals are already within the resolution limits of the sensor system in the area of the process deviations of interest, so that stochastic deviations occur in the signal curves.
c) The signal curves are incomplete due to the discretization.
d) The signal curves are subject to strong noise.
e) The signal curves, even of different physical variables, are interdependent.

### BRIEF SUMMARY

The disclosure therefore addresses a method for determining process characteristic numbers on a cyclically operating machine for processing plastics and other plasticizable materials for producing moldings, a machine operating in this way and a computer program product with a program code which is stored on a computer-readable medium, for carrying out the method in which the above-mentioned disadvantages are avoided by determining process characteristic numbers in such a way that they shift in a suitable manner during process changes such that their informative value is retained.

This is a method for determining process characteristic numbers on a cyclically operating machine for processing plastics and other plasticizable materials for producing moldings, wherein the machine has a controller for carrying out the method, said method comprising the following steps of a reference determination cycle:
a) determining and storing at least one first partial curve profile of a first curve profile of at least one first measurement variable by means of at least one sensor in at least one process cycle,
b) optionally, processing at least in a single-stage manner the at least one first partial curve profile by means of mathematical and/or statistical methods for generating at least one first curve profile derived therefrom,
c) determining and storing at least one first characteristic point of the at least one first partial curve profile or optionally of the at least one first curve derived therefrom,
d) determining and storing at least one further characteristic point using the at least one first characteristic point, which serves as an indexing of the at least one further characteristic point in at least one further partial curve or optionally in at least one further curve profile derived therefrom of a further curve profile of at least one further measurement variable, to determine and store at least one process characteristic number, wherein the further curve profile, the at least one further partial curve profile or the at least one further curve profile derived therefrom are formed by repeating steps a) and b) analogously,
e) post-processing the at least one process characteristic number using mathematical and/or statistical methods to determine and store at least one weighted reference process characteristic number.

The method also comprises the following steps of a production cycle:
f) analogously repeating steps a) to e) to determine and store at least one weighted production process characteristic number, wherein a deviation of the weighted production process characteristic number is determined from the weighted reference process characteristic number and stored,
g) calculating in a deviation-dependent manner and storing at least one value and/or applying at least one stored value in a compensation intervention to at least one predetermined manipulated variable by means of at least one actuator under changing production conditions for updating the at least one weighted production process characteristic number,
h) repeating steps f) and g) to produce further moldings.

Advantageously, process characteristic numbers are determined in such a way that they shift appropriately in the event of process changes so that their informative value is retained.

The need to record complete measurement curve profiles is advantageously avoided by interrupting the recording after defined characteristic numbers have been found and by carrying out the evaluation directly. This makes it possible to compensate for process deviations earlier in the cycle, ideally directly after the deviation and therefore preferably in the same cycle.

Preferably, several signal curves or curve profiles are examined, wherein they are processed in cascade by using the “reference location” of a characteristic number from one curve profile to index a characteristic number in another curve profile. Practical tests on the machine and modeling work or recourse to simulation data are not required.

The method can advantageously be carried out without the intervention of the operator and also when the operator intends to change the settings.

Preferably, the curve profile is thus determined and mathematically and/or statistically processed until the (at least one) desired process characteristic number is detected. After detecting a characteristic value at a characteristic point in the preferably already processed curve profile, the system jumps directly to another curve profile that was recorded and processed at the same time or also with a time delay in order to determine there a dependent process characteristic number.

This process can preferably also be carried out with another characteristic point so that a further dependent process characteristic number can be determined. From several determined (dependent) process characteristic numbers, further dependent process characteristic numbers can in turn be determined. This leads to cascading.

In an advantageous way, a homogenous and weight- or filling degree-constant molding with a predetermined quality can be produced. This suppresses disturbances in the calculations within a process cycle.

The disadvantage of the aforementioned methods, which have to compare complete curve profiles with a reference and can therefore only provide a result of the calculation (e.g., an offset) with a time delay, is remedied by the fact that characteristic points in the profiles can be searched for iteratively and the calculation can usually be completed in the same process phase after they have been recorded. This also makes it possible to detect characteristic points in further curve profiles that would not be detectable as distinguished characteristic points without the indexing from the first curve profile.

There is also disclosed a cyclically operating machine for processing plastics and other plasticizable materials to produce moldings, wherein the machine has a controller for carrying out the method, at least one sensor and at least one actuator, and is suitable for carrying out the method. The machine can thus be operated in a more trouble-free and energy-efficient manner.

There is further disclosed a computer program product comprising a program code stored on a computer-readable, wherein the program code of the computer program product is suitable for carrying out the method by means of the cyclically operating machine. The method-related advantages are thereby achieved.

Preferably, the steps of the reference determination cycle and the steps of the production cycle are carried out analogously to the determination of further process characteristic numbers, whereby at least one further process characteristic number is determined, which is usable in turn/alternatively to update the at least one weighted production process characteristic number. Thus, it is possible to advantageously determine the “appropriate” process characteristic number that is suitable for a compensation intervention depending on the change.

Preferably, the method comprises an analogous iterative repetition of steps a) to d) on at least one further partial curve profile of the first measurement variable and/or the further measurement variable or optionally on at least one further curve profile derived therefrom until a characteristic point is found in the at least one further partial curve profile or a further curve profile derived therefrom, using in each case at least one last examined characteristic point, which serves as an indexing of at least one next characteristic point.

Preferably, the value of the compensation intervention is determined either from a predetermined model or during the running process by iteratively observing the reaction of the process to changes in the machine settings, the environmental conditions or the material properties of the plasticizable materials or as a result of wear processes on elements of the machine. As a result, the machine can, advantageously, in predetermined or automatic manner, react to changing basic conditions and can be operated reliably and energy-efficiently.

In a preferred manner, when a predetermined model is used, this is determined in the reference determination cycle and/or by introducing process knowledge prepared for the method, wherein the model is either known in advance or is obtained by mathematical methods. The use of process knowledge advantageously allows the machine to access experience which can either be derived from the experience of an experienced machine operator and/or which arises during operation, in particular during operation of the respective machine.

Preferably, in step g), before the stored value of the compensation intervention is used, a logical check of the compensation intervention is carried out, on the basis of which the compensation intervention is either executed or rejected. This can advantageously counteract settings that could be detrimental to the operation of the machine or the production of moldings, for example, and the production of bad parts can be avoided. For example, it may be advantageous to divide large compensation interventions over several subsequent cycles and thus prevent a sudden process change.

To further improve these advantages, an operator intervention can preferably be integrated either interactively or in a preset manner into the logical check of the compensation intervention.

Preferably, the logical check advantageously and where appropriate comprises settings that can have a systemic influence on the operation of the machine. In particular, this may involve one or more of the following settings: The value of the compensation intervention, the current process state, a specific machine technology, such as adjustment ranges, time behavior, performance, control aspects and equipment specifics, as well as previous control interventions by an operator. For example, a compensation intervention can be advantageously delayed if a transient operating state is present, e.g., if the compensation parameter is a temperature that must first stabilize before a further adjustment intervention, or if the machine is still in an unstable start-up process.

Preferably, the logical check of the compensation intervention is based on simple or complex if-then conditions and/or on an evaluation using statistical methods, signal processing methods and methods using artificial intelligence. This has the advantage of ensuring a fast check while reducing the computing time. If, for example, several compensation parameters are provided, a faster-acting parameter can preferably be overcompensated and fed back if a slower compensating parameter slowly increases in its effect on the process. In this way, the desired process state can be achieved more quickly.

Preferably, information from different machine parts, such as from different drive trains, from machine- and tool-related signals, from the environment, from the feedback of an operator and from external devices or systems or master computers is included in the logical check of the compensation intervention. This ensures a systemic, holistic picture of the machine's operation, which can be used for logical checks.

Preferably, an operator blocks compensation interventions on manipulated variables and/or preferably sets them. If the method provides several independent compensation mechanisms, for example, the operator can select the currently most appropriate compensation parameters and/or deselect inappropriate ones based on his actual process view. This means that certain processes during the production of the molding and any resulting characteristics of the moldings to be produced can be deliberately suppressed or preferred.

It is very particularly preferable to examine several determined process characteristic numbers in relation to each other, e.g., by means of correlation or regression analyses, in order to advantageously determine the most effective intervention in the respective situation and to eliminate a correlation between characteristic numbers of different curve profiles. This avoids overcompensation, which may occur in a primary shaping process such as injection molding due to interactions between process variables. The process knowledge is taken into account when determining the compensation intervention. If it is determined during the running process, stored characteristic numbers from several cycles are used continuously; if it is determined beforehand, it is applied statically.

Preferably, measurement variables are weighted with material characteristics of the plasticizable materials to be processed, which material characteristics are previously known and/or determined in the process. This advantageously increases the accuracy of the method and allows fluctuations in material properties to be dealt with effectively, particularly when processing recyclates.

Preferably, to determine the further curve profile, a mathematical method is used which, in a selected and/or parameterized manner, generates a curve profile derived from material properties or material class properties, and/or a statistical method is used which, in a weighted manner, generates a curve profile derived from material properties or material class properties. Advantageously, these curve profiles can be used material-specifically to determine the characteristic number and thus represent an additional compensation option.

It is highly preferred that the curve profile is examined only at singular characteristic points of the reference determination/production cycle, wherein the at least one reference/production process characteristic number is searched for by means of iterative signal methods and the evaluation is terminated as soon as this has been determined. This leads advantageously to a reduced computing effort (and reduced complexity). In particular, however, this approach often allows immediate compensation interventions within the same sub-cycle.

The at least one weighted production process characteristic number is preferably updated particularly effectively by using at least one of the following measures:
with an update value that spans several process cycles,
with an adjustment amount that is recalculated cyclically,
in the current sub-process cycle,
in a subsequent sub-process cycle,
in the current process cycle,
beyond the current process cycle, e.g., across several process cycles,
cyclically completely,
in an iterative approach on a cyclical basis,
damped or amplified,
directly with recognition,
as desired cyclically or with a time delay,
depending on stability tests,
depending on logical decision-making processes.

Preferably, stochastic fluctuations of the at least one measurement variable are detected and filtered out by means of statistical and iterative methods in order to exclude them from the further calculation steps. This has the advantage of further reducing the susceptibility of the process to errors and in particular prevents, for example, different sampling increments, manufacturing tolerances and the like on different machine types from having an impermissible influence on the compensation interventions.

The features listed individually in the annexed claims can be combined with one another in a technologically meaningful way and can be supplemented by explanatory facts from the description and by details from the Figures, wherein further variants are shown.

The disclosure will now be explained in greater detail using an exemplary embodiment, in which:

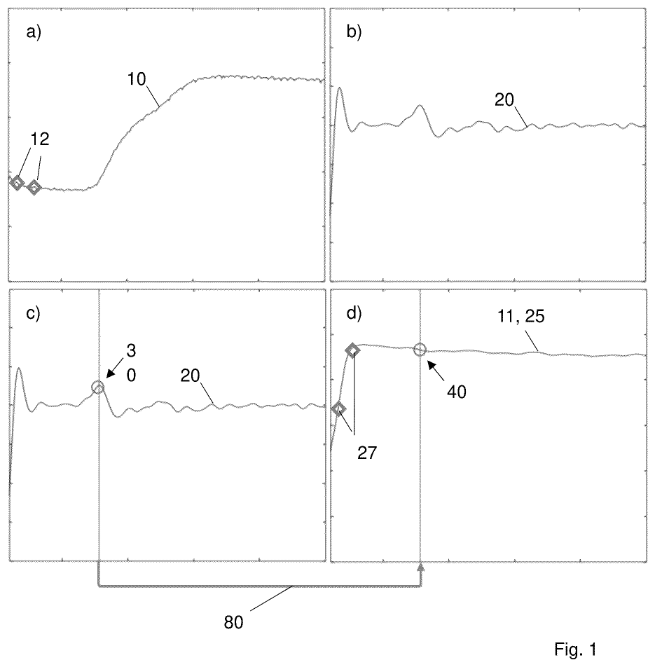

FIG. 1 shows the use of a characteristic value from a 1st measurement variable possibly processed in a multi-stage manner as an index to a process characteristic number in a 2nd measurement variable possibly processed in a multi-stage manner,

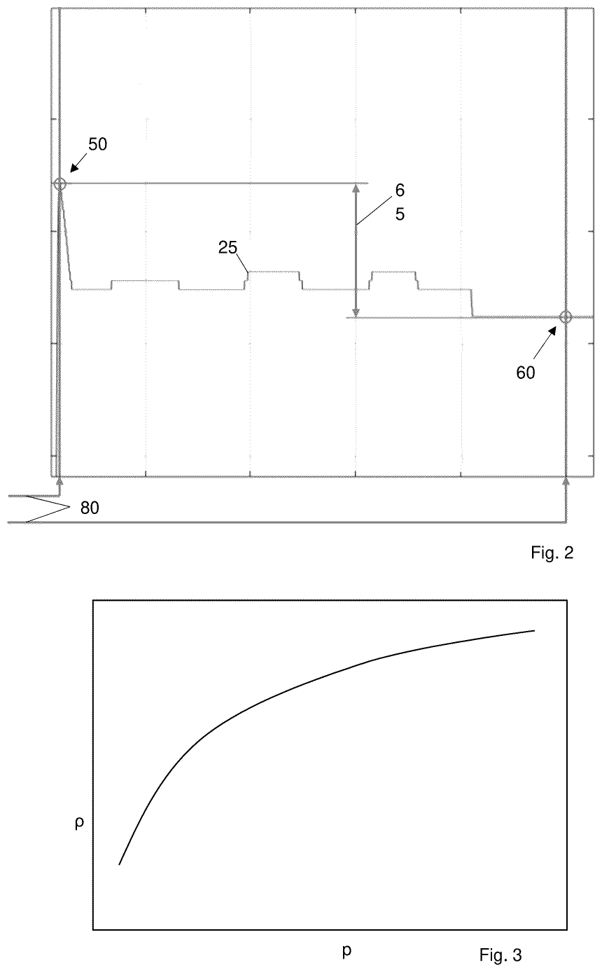

FIG. 2 shows the cascading of the characteristic number determination from several measurement variables by means of indexing to one or more further curve profiles,

FIG. 3 shows an example of material-specific data that can be used analogously to curve profiles from the process according to FIG. 1,

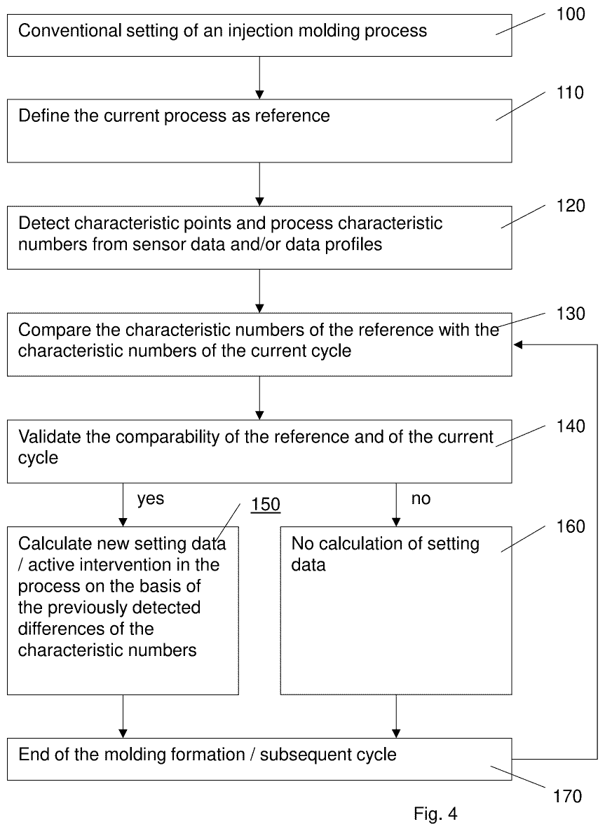

FIGS. 4-6b show various flow charts.

### DETAILED DESCRIPTION OF PREFERRED EXEMPLARY EMBODIMENTS

The disclosure will now be explained in greater detail by way of example with reference to the accompanying drawings. However, the exemplary embodiments are only examples and are not intended to limit the inventive concept to a particular arrangement. Before the disclosure is described in detail, it should be pointed out that it is not limited to the respective components of the device and the respective method steps, as these components and method may vary. The terms used herein are merely intended to describe particular embodiments and are not used in a limiting manner. Furthermore, when the singular or indefinite articles are used in the description or in the claims, this also refers to the plurality of these elements, unless the overall context clearly indicates otherwise.

On the one hand, the disclosure relates to a method for determining process characteristic numbers on a cyclically operating machine for processing plastics and other plasticizable materials for producing moldings, wherein the machine has a controller for carrying out the method, said method comprising the following steps of a reference determination cycle:
a) determining and storing at least a first partial curve profile 12, 27 of a first curve profile 10 of at least one first measurement variable by means of at least one sensor in at least one process cycle,
b) optionally, processing at least in single-stage manner the at least one first partial curve profile 12, 27 by means of mathematical and/or statistical methods for generating at least one first curve profile 20 derived therefrom,
c) determining and storing at least one first characteristic point 29 of the at least one first partial curve profile or optionally of the at least one first curve profile 20 derived therefrom,
d) determining and storing at least one further characteristic point 39, 49, 59 using the at least one first characteristic point 29, which serves as an indexing 80 of the at least one further characteristic point 39, 49, 59 in at least one further partial curve profile 27 or optionally in at least one further curve profile 25 derived therefrom of a further curve profile 11 of at least one further measurement variable, to determine and store at least one process characteristic number 40, 50, 60, wherein the further curve profile 11, the at least one further partial curve profile 27 or the at least one further curve profile 25 derived therefrom are formed by repeating steps a) and b) analogously,
e) post-processing the at least one process characteristic number 40, 50, 60 using mathematical and/or statistical methods to determine and store at least one weighted reference process characteristic number.

The method also comprises the following steps of a production cycle:
f) analogously repeating steps a) to e) to determine and store at least one weighted production process characteristic number, wherein a deviation of the weighted production process characteristic number is determined from the weighted reference process characteristic number and stored,
g) calculating in a deviation-dependent manner and storing at least one value and/or applying at least one stored value in a compensation intervention to at least one predetermined manipulated variable by means of at least one actuator under changing production conditions for updating the at least one weighted production process characteristic number,
h) repeating steps f) and g) to produce further moldings.

Advantageously, a homogenous and weight-constant molding with a predetermined quality can thus be produced. This suppresses disturbances in the calculations within a process cycle and shortens the process cycle times by minimizing the computing times.

The first curve profile of at least one first measurement variable can be an existing curve profile of an existing measurement variable and/or a further curve profile of a further measurement variable, which is then used as the first measurement variable in the method. The same also applies to the process characteristic number, which can be an existing and/or a further process characteristic number that is determined according to the method.

In contrast to the prior art, the determination and storage of curve profiles is generally not carried out completely over the entire process cycle, but can also be carried out over only parts of a process cycle or can also be focused on portions at which significant features or properties of a process cycle regularly become apparent in the process.

Advantageously, the measurement curves are processed iteratively for each individual measuring point until a characteristic point is detected, at which the further detection can be interrupted and the subsequent evaluation steps are initiated. The detection of such a characteristic point provides a process characteristic number, but in particular an indexing in a further curve profile. In principle, it is also possible to carry out several reference cycles and evaluate the values or curve portions determined in the process (weighting, averaging, sorting, etc.) in order to arrive at the reference values then used.

The measurement variables of the sensors can be, for example, an injection pressure, screw travel, torque, pressure or temperature in a screw antechamber of a screw conveyor or a temperature of a mold of an injection molding machine.

The manipulated variables of the actuators can be, for example, a switching point, a holding pressure level, a holding pressure duration or an injection profile.

The measurement variables can be detected over one or more process cycles. Furthermore, manipulated variables can be changed in one or any number of process cycles.

The at least one curve profile can be processed possibly using multivariate mathematical and/or multivariate statistical methods. For example, a pressure curve profile can be examined using a first process characteristic number in order to obtain an indexing of a position in a processed temperature curve or a processed material property profile. Curve profiles that are not determined in the production process, but contain basic information on process interrelationships, for example, can be integrated into the method in a similar way.

For example, possibly multi-stage processing of a curve profile can be carried out using mathematical and/or statistical methods from a simple filtering, a derivative (differential calculus) or an integration (integral calculus) or by applying one or more of these methods multiple times. A possibly multi-stage processing is therefore to be understood as either single-stage or multi-stage processing.

FIG. 1 shows an exemplary process for determining process characteristic numbers. FIG. 1a) shows the curve profile 10 of a first measurement variable. This is either used as in its existing form, but is usually processed using mathematical and/or statistical methods. The result is shown in FIG. 1b) as a curve profile 20 of the processed first measurement variable, processed possibly in a multi-stage manner. FIG. 1c) shows the determination of a first process characteristic number 30 in the curve profile 20, processed possibly in a multi-stage manner, at a characteristic point of the curve profile 20. By means of indexing 80 of the first process characteristic number 30, a second process characteristic number 40 is determined in the curve profile 25, processed possibly in a multi-stage manner, of a second measurement variable. The curve profiles are preferably recorded and processed in sub-portions, particularly preferably in the form of individual measuring points, until a termination criterion in the form of a characteristic point is reached. The determined process characteristic numbers 30 or 40 and the indexing 80 are usually located at the end or shortly before the end of the recorded and processed portion of the curve profiles 10, 11, 20, 25.

Analogously to FIG. 1d, FIG. 2 shows the cascading of the determination of characteristic numbers from several measurement variables by means of indexing 80 to one or more further curve profiles, from which one or more further process characteristic numbers 50, 60 are formed. Further process characteristic numbers 65 can be determined from several process characteristic numbers formed in this way. The measurement variable can be weighted with material characteristics of the plasticizable materials to be processed, which material characteristics are previously known and/or are determined in the process.

The value of the compensation intervention can be determined either from a predetermined model or during the running process by iteratively observing the reaction of the process to changes in the machine settings, the environmental conditions, the material properties of the plasticizable materials or as a result of wear processes on elements of the machine.

A pre-determined model can, for example, be a relationship, determined by a model, between certain curve characteristics in the curve profile of a measurement variable—or its differentials or integrals—to related characteristics of a second measurement variable—or its differentials or integrals—which have already been determined as being demonstrably correct in principle or on the respective machine.

The value of the compensation intervention can be determined as described in the following steps:
1. cyclically determining the deviation between reference process characteristic numbers from the reference determination cycle and analogously defined and determined process characteristic numbers in a first production cycle,
2. executing a compensation intervention with a predefined setting variable with a predefined value in the same cycle,
3. optionally: transitioning to a second production cycle,
4. cyclically determining the deviation between reference process characteristic numbers and process characteristic numbers of the current second production cycle,
5. adaptively adjusting the value of the compensation intervention until the process characteristic number deviation is balanced.

If a predetermined model is used, this can be determined in the reference determination cycle and/or by introducing process knowledge prepared for the method, which is either known in advance or obtained using mathematical methods.

Advantageously, in step g), before the stored value of the compensation intervention is used, a logical check of the compensation intervention can be carried out, on the basis of which the compensation intervention is either executed or rejected

The logical check can comprise the value of the compensation intervention, the current process state, a specific machine technology, such as adjustment ranges, time behavior, performance, control aspects and equipment specifics, as well as previous control interventions by an operator.

The logical check of the compensation intervention can be based on simple or complex if-then conditions and/or on an evaluation using statistical methods, signal processing methods and methods using artificial intelligence.

The logical check of the compensation intervention can include information from different machine parts, such as from different drive trains, from machine- and tool-related signals, from the environment, from operator feedback and from external devices or systems or master computers.

The automatic execution of the compensation intervention can advantageously be preceded by an interactive assessment/approval of an operator. In an advantageous way, an operator can block and/or preferably set compensation interventions on manipulated variables. This allows certain processes during the production of moldings and any resulting characteristics of the moldings to be produced to be deliberately suppressed or preferred. The operator thus retains decision-making authority despite the extensive automation of the method.

Several determined process characteristic numbers 30, 40, 50, 60, 65 can be examined in relation to each other, e.g., using correlation or regression analyses. For example, the temperature-dependent component can be extracted from a pressure-dependent process characteristic number.

Measurement variables can advantageously be weighted with material characteristics of the plasticizable materials to be processed, which material characteristics are previously known and/or determined in the process. This increases the accuracy of the method. FIG. 3 shows this schematically using a melt density curve ρ over a pressure p of a plasticizable material with the melting temperature T of the material increasing from top to bottom.

The curve profile can advantageously be examined only at singular characteristic points of the reference determination/production cycle, wherein the at least one reference/production process characteristic number 30, 40, 50, 60, 65 is searched for by means of iterative signal methods and the evaluation is terminated as soon as this has been determined. This allows compensation to take place in the same sub-cycle if necessary.

The at least one weighted production process characteristic number is updated selectively:
with an update value that spans several process cycles,
with an adjustment amount that is determined cyclically,
in the current sub-process cycle,
in a subsequent sub-process cycle,
in the current process cycle,
beyond the current process cycle, e.g., across several process cycles,
cyclically completely,
in an iterative approach on a cyclical basis,
damped or amplified,
directly with recognition,
as desired cyclically or with a time delay,
depending on stability tests,
dependent on logical decision-making processes.

Stochastic fluctuations of the at least one measurement variable can be detected and filtered out by means of statistical and iterative methods in order to exclude them from the further calculation steps. This further increases the quality of the moldings to be produced or additionally reduces the susceptibility of the process to errors and improves the stability of the method.

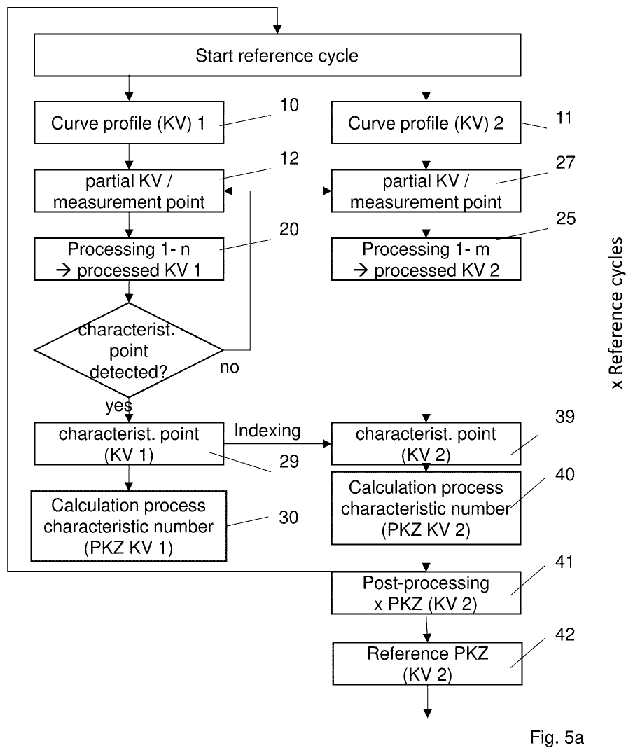

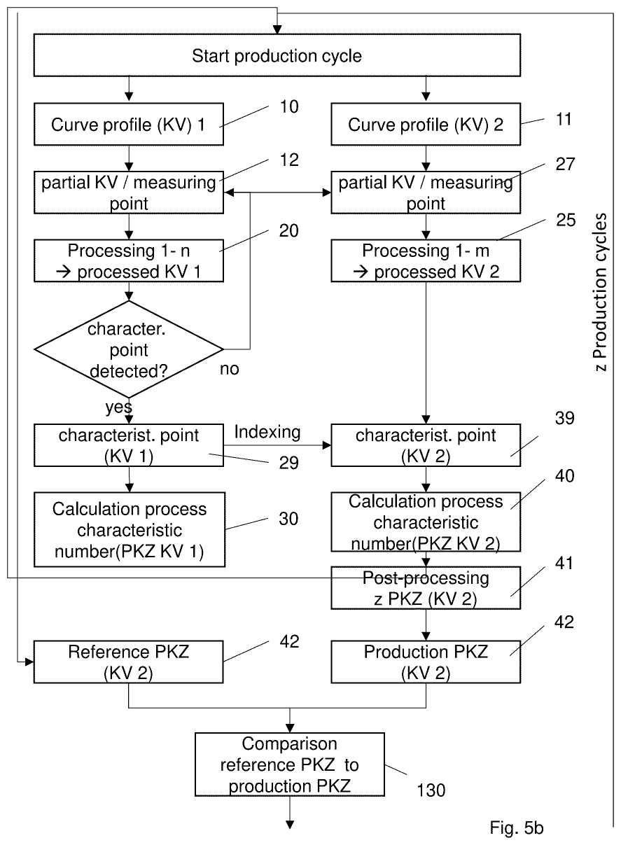

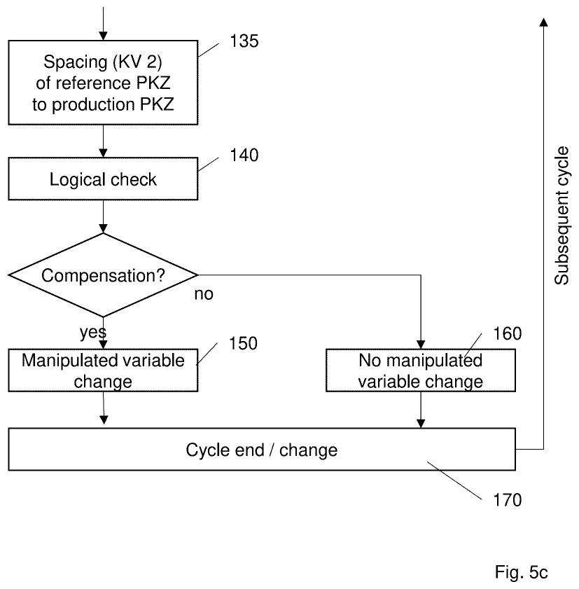

In the following, the disclosure will be explained with reference to the method sequences shown in FIGS. 4 to 5c. FIG. 4 explains the basic method sequence, while FIG. 5 shows further details in particular.

First, according to FIG. 4, a conventional setting of an injection molding process is carried out on the machine for processing plasticizable materials in step 100. For this purpose, the injection molding process is set so that the machine is ready to run, i.e., an injection molding can be produced in principle. In the following step 110, a current injection molding process is defined as a reference. This reference process is an injection molding process in which a good part can already be produced. However, this is not absolutely necessary. The reference process can also be defined in response to an operator input, automatically or also triggered by external systems, in which the operator or artificial intelligence determines that the current process is basically suitable as a reference.

If such a process is established as a reference, in the next step at least a partial curve profile 12, 27 of at least a first measurement variable is determined and stored by means of at least one sensor in a process cycle, wherein in order to record specific characteristic numbers or characteristic points from the curve profiles 10, 25, which are recorded by sensors, specific process characteristic numbers or characteristic points in step 30, 30 are recorded in step 120.

The sensor data can come from any one or more sensor(s), such as a sensor for determining the injection pressure, a position sensor for determining the screw path or a sensor for detecting the torque of the drive. Other sensor data can also be used, such as the pressure in the screw antechamber or the temperature at the injection molding unit and/or mold. Curve profiles from other sources can also be processed in the same way, such as material data or similar that are available in curve form (see FIG. 3).

Optionally, the at least one first curve profile is processed in an at least single-stage manner using mathematical and/or statistical methods to generate a curve profile 20 derived therefrom. Process characteristic numbers can be recorded over part of a cycle, an entire cycle or even over several cycles, possibly using statistical methods and possibly using specially adapted reference sequences. Characteristic points include, for example, a switching point between injection and holding pressure, the holding pressure level, the holding pressure duration or a specific injection profile, but generally any point in a curve profile from sensor data or also from other data sources, such as profiles of material characteristic values that can be obtained using mathematical/statistical methods.

If curve profiles were already available beforehand, the method can also determine further curve profiles based on other measurement variables.

In the following step 130, the process characteristic numbers or characteristic points of the reference are compared with the corresponding values in the current process cycle.

In step 140, the comparability of the reference and of the current cycle is validated. If this comparability exists, new setting data is calculated in step 150 or an active intervention in the process is carried out using the previously recorded differences in the process characteristic numbers between the reference and the current cycle. In this case, the formation of the molding is completed in step 170 and the method is continued in step 130 with the changed setting data.

If step 140 shows that the reference and the current cycle are not comparable, no setting data is calculated in accordance with step 160. Instead, an output or an intervention in the process takes place in that the manufactured molding is marked as a bad part, the cycle is stopped at the end and/or an error evaluation takes place.

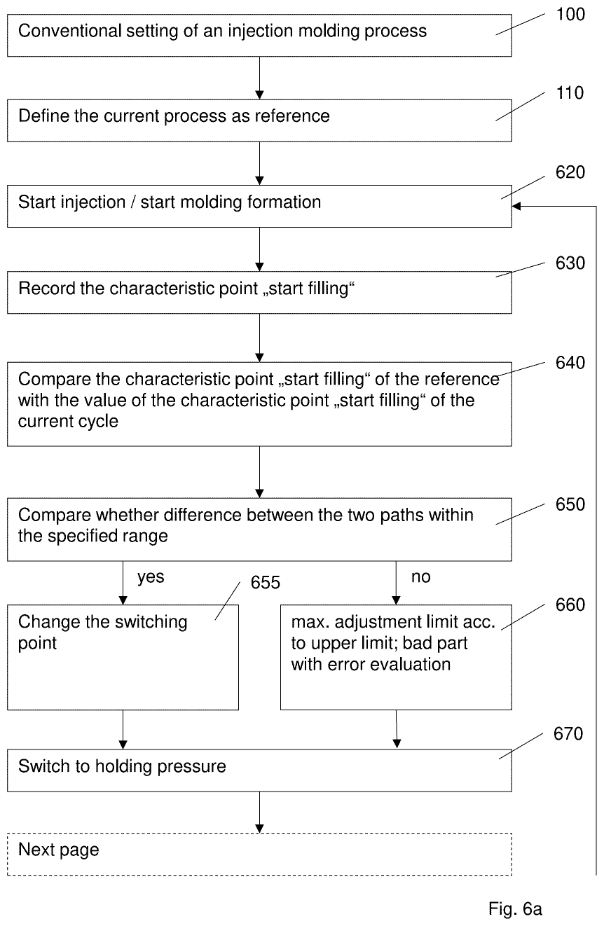

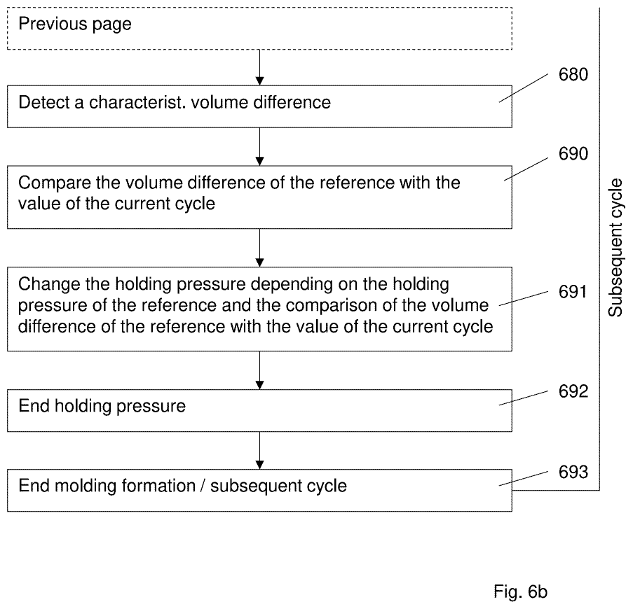

FIGS. 5a to 5c describe the specific method sequence, which is underlaid on the rough flow charts shown in FIG. 4 and FIG. 6.

From FIG. 4, steps 110 and 120, it can be seen that characteristic points or process characteristic numbers are first determined in (one or more) reference cycles. This section is further detailed in FIG. 5a.

FIG. 5a shows how curve profiles are detected in part, for example from two curve profiles 10, 25 (any number can generally be included in the processing), wherein a partial recording can in the simplest case mean a single measuring point 12, 27 per processed curve profile. The recorded sub-portion of each curve profile is preferably processed (possibly also several times). Processing is understood here to mean any application of mathematical methods, such as simple counting, sorting, filtering, differentiation, integration, etc.

The partial sequences are recorded iteratively step by step. As soon as a predefined characteristic point is reached on curve profile 1, a process characteristic number can be determined therefrom if required. In any case, however, the characteristic point is used as a termination criterion for the recording and processing in all simultaneously examined curve profiles and is used as an indexing of curve profile 1 in the further curve profile(s), where, with its help, characteristic points 39 and process characteristic numbers 40 of at least one further curve profile 25 are determined.

The process characteristic numbers 40 are determined over at least one reference cycle and can be post-processed using mathematical/statistical methods (step 41), e.g., in the form of an averaging, weighting or the like. After completion of the reference cycles, one or more reference process characteristic numbers 42 from one or more curve profiles 25 are available.

FIG. 4, step 130 shows that the characteristic points or process characteristic numbers of the reference are compared with those of the current cycle.

For this purpose, as shown in FIG. 5b, the sequence from FIG. 5a for determining reference values is carried out identically for each individual one of the z production cycles and the one or more production process characteristic numbers 42 of each individual production cycle are compared with the one or more reference process characteristic numbers 42 (step 130). The production process characteristic numbers can also be further processed mathematically in step 41 over several cycles in order to arrive at cross-cycle production process characteristic numbers 42.

According to FIG. 5c, the comparison (step 130) between production process characteristic number and reference process characteristic number produces a value for the spacing 135 between the process characteristic numbers. Any mathematical spacing measures can be used for this purpose.

The spacing value is then subjected to a logical check (step 140), which determines whether a compensation intervention is carried out on an intended setting variable (step 150) or omitted (step 160). An example of such a logical check can be to determine the comparability of the reference curve profiles and the production curve profiles. Other possibilities were mentioned in the description of the exemplary embodiments. All appropriate mathematical methods can be used. Decisive operator intervention may also be possible at this juncture.

FIGS. 6a, 6b show an overview of an application of the method on the basis of a specific influence on the switching point Up. It should be taken into account here that, specifically, method steps according to FIG. 1 or the sequence in FIGS. 5a-5c are carried out.

As explained according to FIG. 4, a conventional injection molding process is first set in steps 100 and 110 and then a current process cycle is defined as a reference.

The sequence starts with the injection or the formation of the molding in step 620. In step 630, a characteristic point of the screw conveyor, namely the characteristic point “start filling” sf_{ref} is detected as the characteristic point and corresponds to the time at which plasticizable material is injected into the injection mold. In step 640, the screw path sf_{ref} of the reference process cycle is compared with the value sf from the current cycle to give

$${ds}_{i} = {sf}_{ref} - {sf}_{i}$$

In step 650 it is now checked whether the maximum permissible differential value dsₘₐₓ is greater than or equal to the determined value dsᵢ. If this is the case, the switching point Up is changed in step 655 as follows to give

$${Up}_{neu} = {Up}_{soll} + {ds}_{i} * k$$

wherein
Upₙₑᵤ is the adjusted switching point,
Upₛₒₗₗ is the previously set setpoint value of the switching point, and
k is a configurable cycle-dependent factor and/or a material-dependent factor.

However, if the comparison in step 650 has revealed that the value dsᵢ>dsₘₐₓ, the maximum adjustment path according to the set upper limit has been exceeded, so that in step 660 the molding is reported as a bad part with subsequent error evaluation.

In step 670, a switch to holding pressure takes place after injection has taken place, wherein a characteristic volume difference s_{NDdif}, e.g., between the start and end of the holding pressure in step 680 in FIG. 6b is now recorded as a further process characteristic number. In step 690, this volume difference s_{NDdiff} is compared with the reference value from the reference determination cycle to give

$$Δ {s}_{NDdiff} = {s}_{NDdiff , ref} - {s}_{NDdiff , akt}$$

wherein
s_{NDdiff, ref}=volume difference in the reference cycle
s_{NDdiff, akt}=volume difference in the current cycle

In step 691, the holding pressure is changed depending on ND_{ref} and Δs_{NDdiff}.

With step 692, the holding pressure is completed and thus the forming of a molding is also completed in step 693, so that the next cycle continues with the information obtained in step 620. This means that the corresponding moldings can be produced in the following cycles.

The disclosure also relates to a cyclically operating machine for processing plastics and other plasticizable materials to produce moldings, wherein the machine has a controller for carrying out the method, at least one sensor and at least one actuator, wherein the machine is suitable for carrying out the method.

Furthermore, the disclosure relates to a computer program product comprising a program code stored on a computer readable medium, wherein the program code of the computer program product is suitable for carrying out the method by means of the cyclically operating machine.

It goes without saying that this description can be subject to a wide range of modifications, changes and adaptations which are within the scope of equivalents to the appended claims.

1.-19. (canceled)

20. A method for determining process characteristic numbers on a cyclically operating machine for processing plastics and other plasticizable materials for producing moldings, wherein the machine has a controller for carrying out the method, said method comprising the following steps of a reference determination cycle:
a) determining and storing at least a first partial curve profile of a first curve profile of at least one first measurement variable by means of at least one sensor in at least one process cycle,
b) determining and storing at least one first characteristic point of the at least one first partial curve profile,
c) determining and storing at least one further characteristic point using the at least one first characteristic point, which serves as an indexing (80) of the at least one further characteristic point in at least one further partial curve profile of at least one further measurement variable, to determine and store at least one process characteristic number, wherein the further curve profile or the at least one further partial curve profile are formed by repeating step a) analogously,
characterized by,
d) post-processing the at least one process characteristic number using at least one of mathematical or statistical methods to determine and store at least one weighted reference process characteristic number,
and comprising the steps of a production cycle:
e) analogously repeating steps a) to d) to determine and store at least one weighted production process characteristic number, wherein a deviation of the weighted production process characteristic number is determined from the weighted reference process characteristic number and stored,
f) at least one of calculating in a deviation-dependent manner and storing at least one value or applying at least one stored value in a compensation intervention to at least one predetermined manipulated variable by means of at least one actuator under changing production conditions for updating the at least one weighted production process characteristic number,
g) repeating steps e) and f) to produce further moldings.

21. The method in accordance with claim 20, wherein the first partial curve profile is processed at least in a single-stage manner by at least one of mathematical or statistical methods for generating at least one first curve profile derived therefrom after step a) and is used as the first partial curve profile in the following steps b) to f).

22. The method in accordance with claim 20, wherein the further curve profile is processed at least in a single-stage manner by at least one of mathematical or statistical methods for generating at least one further curve profile derived therefrom after step a) and is used as the further partial curve profile in the following steps b) to f).

23. The method in accordance with claim 20, wherein steps a) to d) from the reference determination cycle and steps e) and f) from the production cycle are carried out analogously to determine further process characteristic numbers, as a result of which at least one further process characteristic number is determined, which is usable either in turn or alternatively to update the at least one weighted production process characteristic number.

24. The method in accordance with claim 20, wherein it comprises an analogous iterative repetition of steps a) to c) on at least one further partial curve profile of at least one of the first measurement variable or the further measurement variable until a characteristic point is found in the at least one further partial curve profile, using in each case at least one last examined characteristic point, which serves as an indexing of at least one next characteristic point.

25. The method in accordance with claim 20, wherein the value of the compensation intervention is determined either from a predetermined model or in the running process by iterative observation of the reaction of the process to changes in at least one of the variables, comprising machine settings, environmental conditions, material properties of the plasticizable materials, or as a result of wear processes on elements of the machine.

26. The method in accordance with claim 25, wherein, when a predetermined model is used, this model is at least one of being determined in the reference determination cycle or being introduced as process knowledge prepared for the method, which is either known in advance or is obtained by means of mathematical methods.

27. The method in accordance with claim 20, wherein in step f), before the stored value of the compensation intervention is used, a logical check of the compensation intervention is carried out, on the basis of which the compensation intervention is either executed or rejected.

28. The method in accordance with claim 27, wherein the logical check comprises the value of the compensation intervention, the current process state, a specific machine technology, adjustment ranges, time behavior, performance, control aspects and equipment specifics, as well as previous control interventions by an operator.

29. The method in accordance with claim 27, wherein the logical check of the compensation intervention is based on at least one of simple or complex if-then conditions or on an evaluation using statistical methods, signal processing methods and methods using artificial intelligence.

30. The method in accordance with claim 27, wherein information from different machine parts, from different drive trains, from machine- and mold-related signals, from the environment, from the feedback of an operator and from external devices or systems or master computers is included in the logical check of the compensation intervention.

31. The method in accordance with claim 20, wherein the automatic execution of the compensation intervention is preceded by an interactive assessment or approval of an operator.

32. The method in accordance with claim 20, wherein an operator at least one of blocks or sets compensation interventions on manipulated variables.

33. The method in accordance with claim 20, wherein several determined process characteristic numbers are examined in relation to one another.

34. The method in accordance with claim 20, wherein measurement variables are weighted with material characteristics of the plasticizable materials to be processed, which material characteristics are at least one of previously known or determined in the process.

35. The method in accordance with claim 20, wherein, to determine the further curve profile, a mathematical method is used which, in at least one of a selected or parameterized manner, generates a curve profile derived from material properties or material class properties, or a statistical method is used which, in a weighted manner, generates a curve profile derived from the material properties or the material class properties.

36. The method in accordance with claim 20, wherein the curve profile is examined only at singular characteristic points of at least one of the reference determination cycle or production cycle, and wherein the at least one of the reference process characteristic number or the production process characteristic number is searched for by means of iterative signal methods and the evaluation is terminated as soon as this has been determined.

37. The method in accordance with claim 20, wherein the at least one weighted production process characteristic number is updated with at least one of the following measures:
an update value that spans several process cycles,
an adjustment amount that is recalculated cyclically,
in the current sub-process cycle,
in a subsequent sub-process cycle,
in the current process cycle,
beyond the current process cycle, e.g., also across several process cycles,
cyclically completely,
in an iterative approach on a cyclical basis,
damped or amplified,
directly with recognition,
as desired cyclically or with a time delay,
depending on stability tests,
depending on logical decision-making processes.

38. The method in accordance with claim 20, wherein stochastic fluctuations of the at least one measurement variable are detected and filtered out by means of statistical and iterative methods in order to exclude them from further calculation steps.

39. A cyclically operating machine for processing plastics and other plasticizable materials, configured for producing moldings, wherein the machine has a controller for carrying out the method, at least one sensor and at least one actuator, wherein the machine is suitable for carrying out the method in accordance with claim 20.

40. A computer program product comprising a program code stored on a computer-readable medium, wherein the program code of the computer program product is suitable for carrying out the method in accordance with claim 1 by means of the cyclically operating machine in accordance with claim 39.
